(19) United States
(12) Patent Application Publication
(10) Pub. No.: US 2025/0370995 A1
(43) Pub. Date: Dec. 4, 2025

(54) SYSTEMS AND METHODS FOR PROVIDING MODULAR AGENTS FOR LARGE LANGUAGE MODELS

(71) Applicant: Verizon Patent and Licensing Inc., Basking Ridge, NJ (US)

(72) Inventors: Johnathan AUSTIN, Roanoke, TX (US); Fijula KUNIYIL, Irving, TX (US); Dhaval V. THAKER, Wesley Chapel, FL (US)

(73) Assignee: Verizon Patent and Licensing Inc., Basking Ridge, NJ (US)

(21) Appl. No.: 18/678,623

(22) Filed: May 30, 2024

(51) Int. Cl. G06F 16/242; G06F 16/248

(52) U.S. Cl. CPC G06F 16/243; G06F 16/248

(57) ABSTRACT

A device may receive a query from a user device, evaluate the query to generate query evaluation results, and generate an action plan for the query. The device may utilize a tools module to generate environment information, and may utilize a knowledge module to generate knowledge information. The device may utilize a memory module to generate memory information, and may utilize an intuition module to determine logical inferences about the query. The device may process the action plan for the query and the logical inferences about the query, with a large language model, to generate a response to the query, and may determine whether the response answers the query. The device may utilize a reflect module to modify the response and generate a final response based on determining that the response answers the query, and may provide the final response to the user device.

### BACKGROUND

In the rapidly evolving field of artificial intelligence (AI) and large language models (LLMs), systems known as agents are designed to mimic human reasoning and responses to dynamic environments.

### BRIEF DESCRIPTION OF THE DRAWINGS

FIGS. 1A-1J are diagrams of an example associated with providing modular agents for LLMs.

FIG. 2 is a diagram of an example environment in which systems and/or methods described herein may be implemented.

FIG. 3 is a diagram of example components of one or more devices of FIG. 2.

FIG. 4 is a flowchart of an example process for providing modular agents for LLMs.

### DETAILED DESCRIPTION OF EXAMPLE EMBODIMENTS

The following detailed description of example implementations refers to the accompanying drawings. The same reference numbers in different drawings may identify the same or similar elements.

Agents are important in extending the utility of LLMs, since the agents use tools, memory, and environmental observations to enrich the capabilities of the LLMs. However, this method faces inherent limitations, particularly when responding to general inquiries or managing context for follow-up questions to the LLMs. The retrieval-augmented generation (RAG) architecture combines the power of information retrieval and neural-network-based generation to enhance knowledge retrieval systems. The RAG architecture, while innovative in its approach to question answering, is not designed to handle general or ambiguous queries and may provide unnecessary document retrieval for these instances. Additionally, the current techniques for utilizing LLMs do not adeptly manage follow-up questions that require an understanding of the context from previous interactions. These challenges inhibit an agent's ability to deliver succinct and relevant responses, thus impacting a user experience and the overall performance of the LLM. Thus, current techniques for utilizing LLMs consume computing resources (e.g., processing resources, memory resources, communication resources, and/or the like), networking resources, and/or other resources associated with failing to properly answer questions with an agent and an LLM, handling user complaints due to failing to properly answer questions appropriately and efficiently, providing incorrect recommendations based on poorly designed agent and LLM systems, providing irrelevant and inaccurate responses based on poorly designed agent and LLM systems, and/or the like.

Some implementations described herein provide an agent system that provides modular agents for LLMs. For example, the agent system may receive a query from a user device, evaluate the query to generate query evaluation results, and generate an action plan for the query based on the query evaluation results. The agent system may utilize a tools module to generate environment information based on application programming interfaces, function calls, and terminal access, and may utilize a knowledge module to generate knowledge information based on well-established facts and business logic. The agent system may utilize a memory module to generate memory information based on short term information and inference information, and may utilize an intuition module to determine logical inferences about the query based on the query evaluation results, the environment information, the knowledge information, and the memory information. The agent system may process the action plan for the query and the logical inferences about the query, with a large language model, to generate a response to the query, and may determine whether the response answers the query. The agent system may utilize a reflect module to modify the response and generate a final response based on determining that the response answers the query, and may provide the final response to the user device.

In this way, the agent system provides modular agents for LLMs. For example, the agent system may mimic human cognitive processes for technical enhancements in human-AI interaction. The agent system may receive an inquiry from a user and may utilize an intuition module or component within a reasoning module to generate a response. The agent system may provide the response to the user. The agent system may restrict the storage duration of inquired information based on predefined parameters, and may refresh the intuition module capabilities by updating the intuition module with new information. The agent system may access external databases, and may update a knowledge module with new information. The agent system may limit recall by excluding time-sensitive data, and may assess inquiries against intuitive understanding thresholds. Thus, the agent system may conserve computing resources, networking resources, and/or other resources that would have otherwise been consumed by failing to properly answer questions appropriately and efficiently with an agent and an LLM, handling user complaints due to failing to properly answer questions appropriately and efficiently, providing incorrect recommendations based on poorly designed agent and LLM systems, providing irrelevant and inaccurate responses based on poorly designed agent and LLM systems, and/or the like.

The agent system may employ enhanced strategies for data retention and recall, comparable to human short term and working memory models, leading to optimized storage and retrieval processes. This may mitigate resource load by preventing the agent system from engaging in unnecessary database interactions for information that can be quickly accessed or inferred internally. Through the use of function calls, terminal access, and application programming interfaces (APIs) for real-time updates, the agent system may enhance computational efficiency and minimize unnecessary data processing. The architectural modularity of the agent system enables seamless extension with new functionalities and repurposing across diverse projects, thus conserving developmental resources. The structured memory management and the intuition-driven querying mechanism ensure that the agent system maintains high processing efficiency by limiting the processing of extraneous or dated information, which in turn conserves processing resources, memory resources, networking resources, and/or the like.

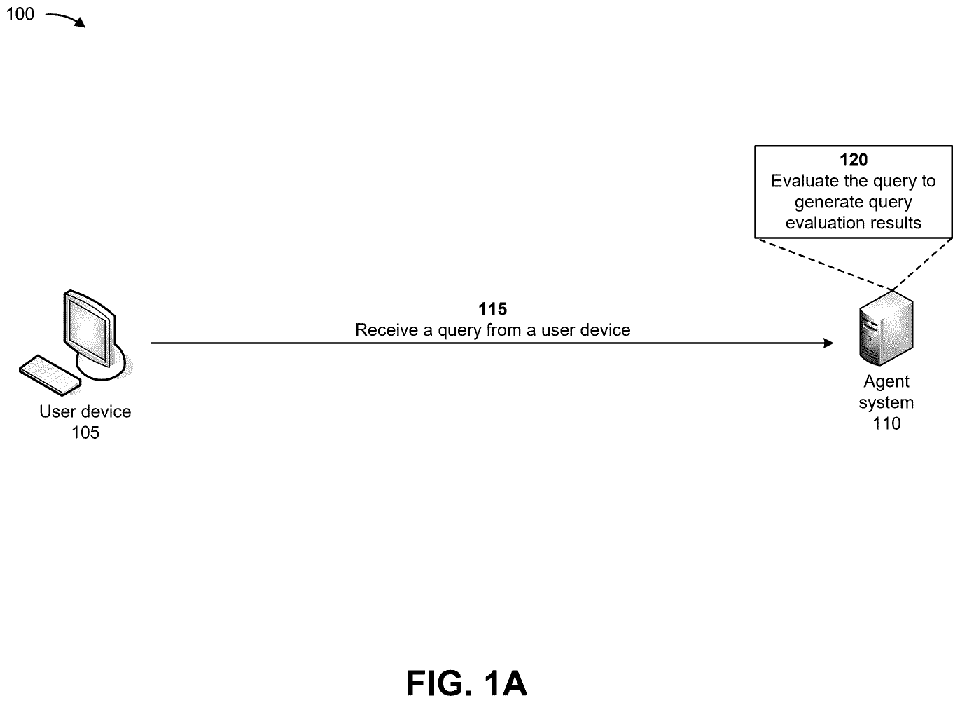

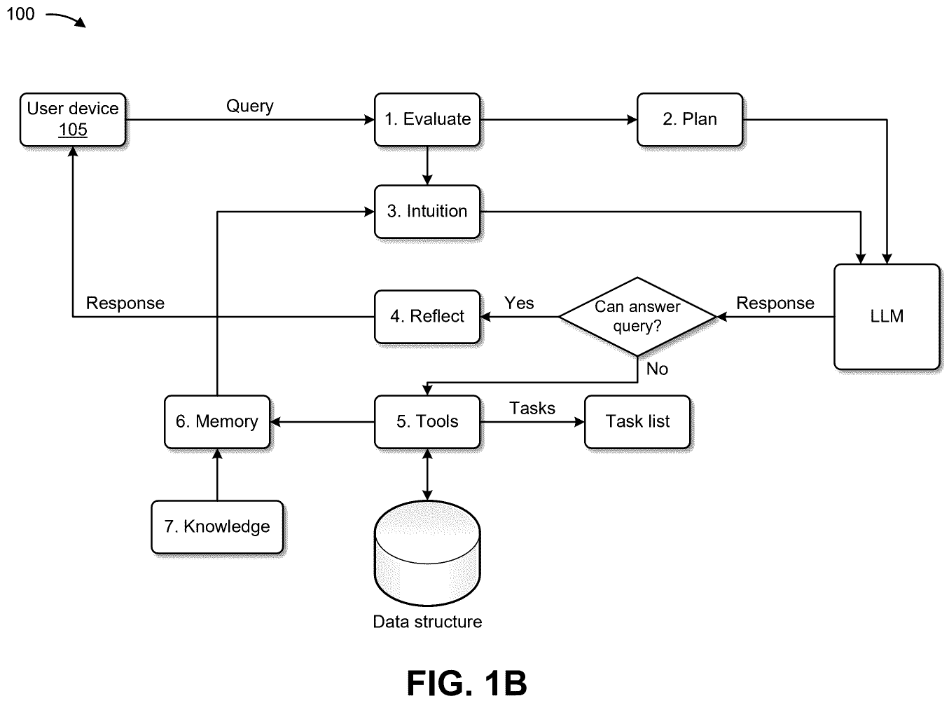

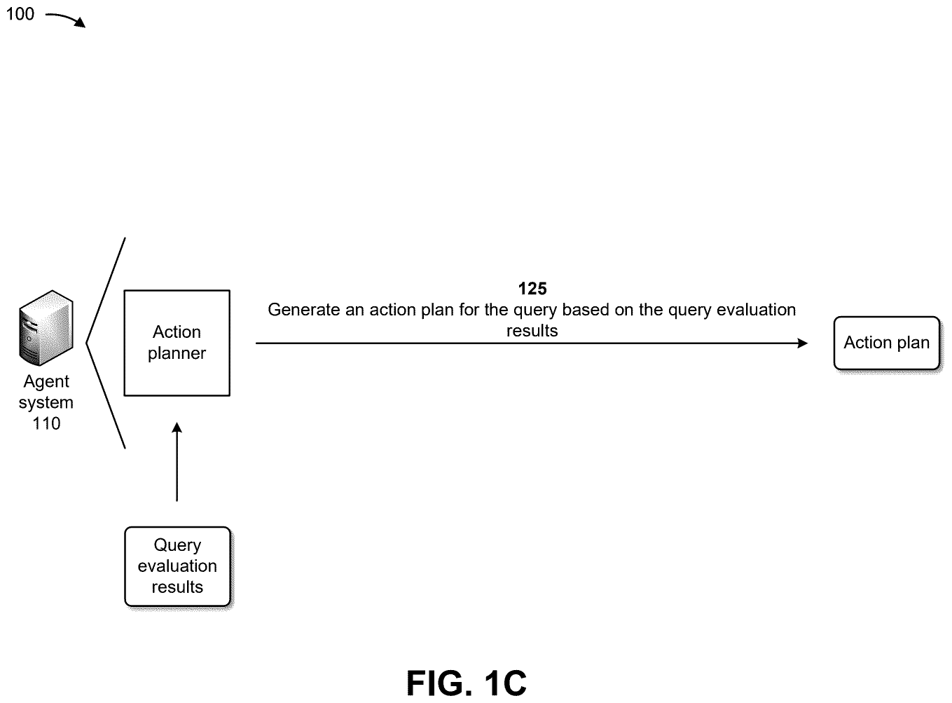

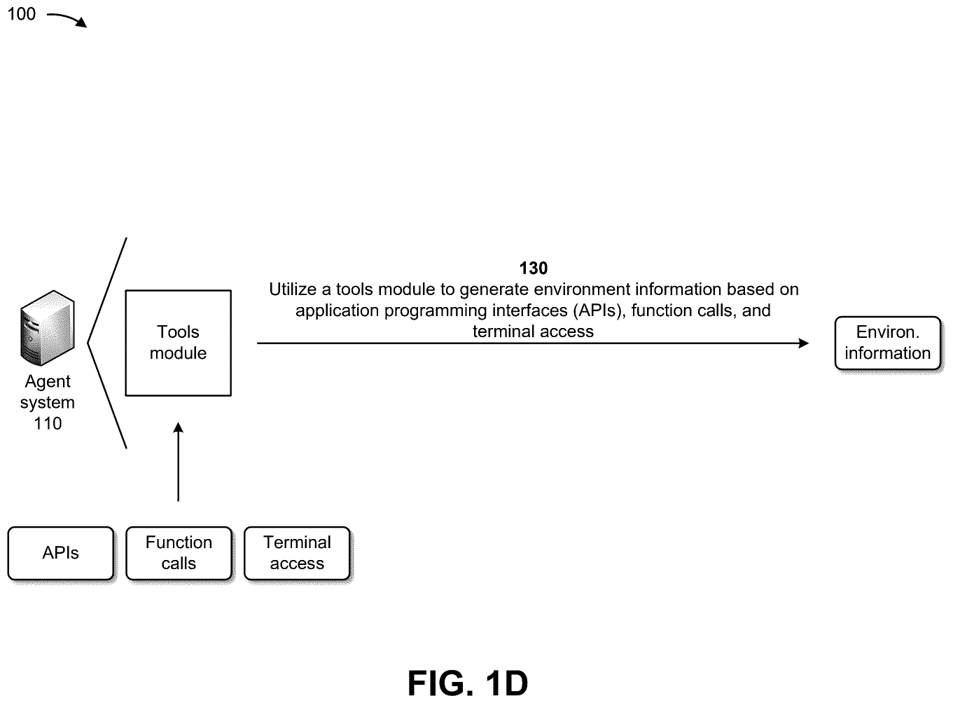

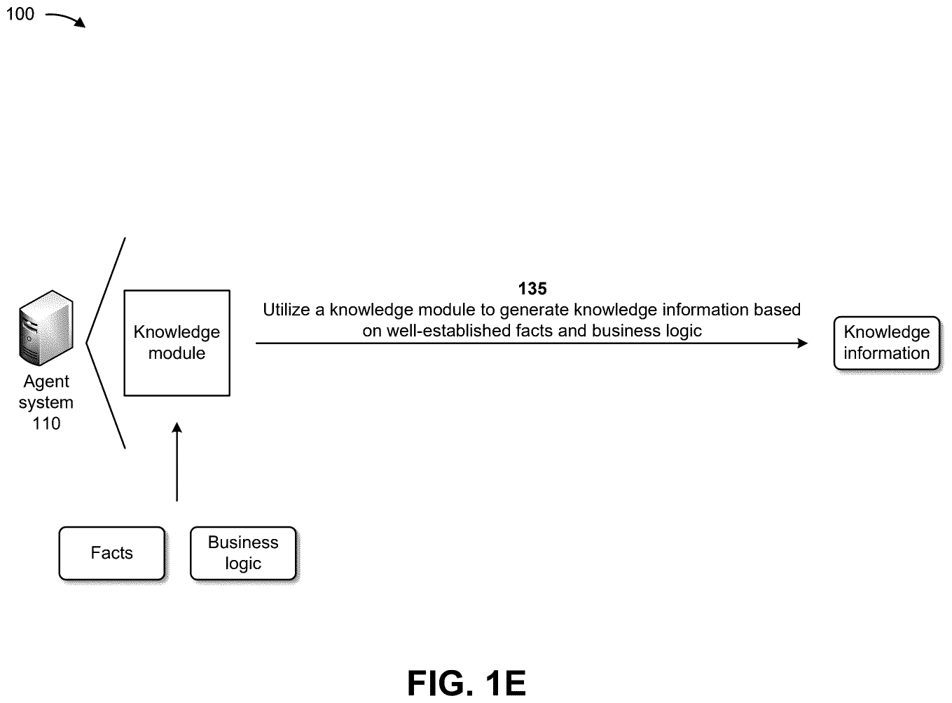

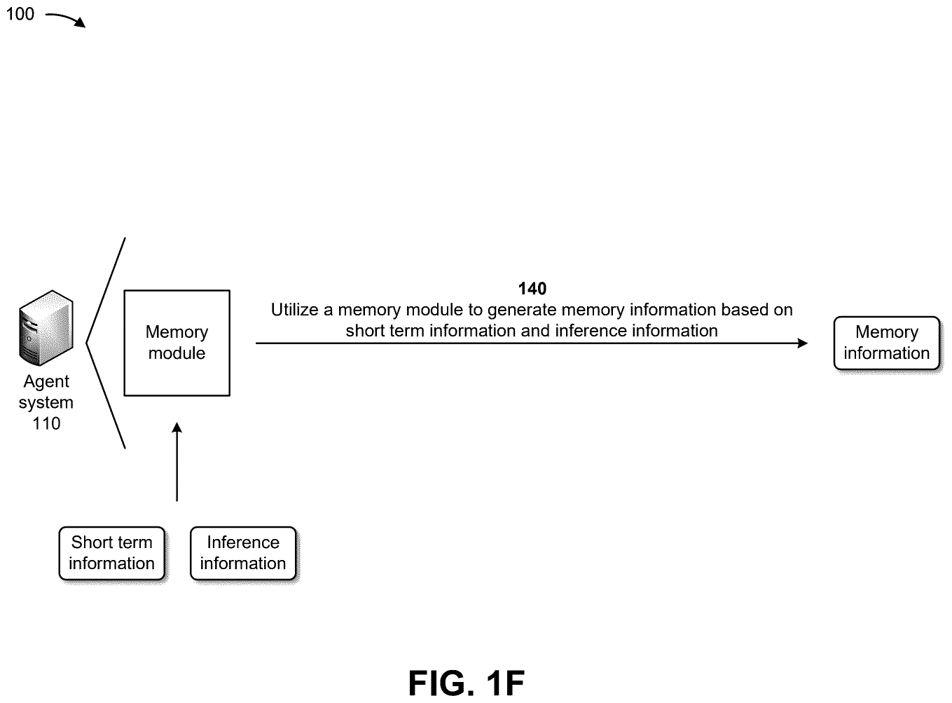

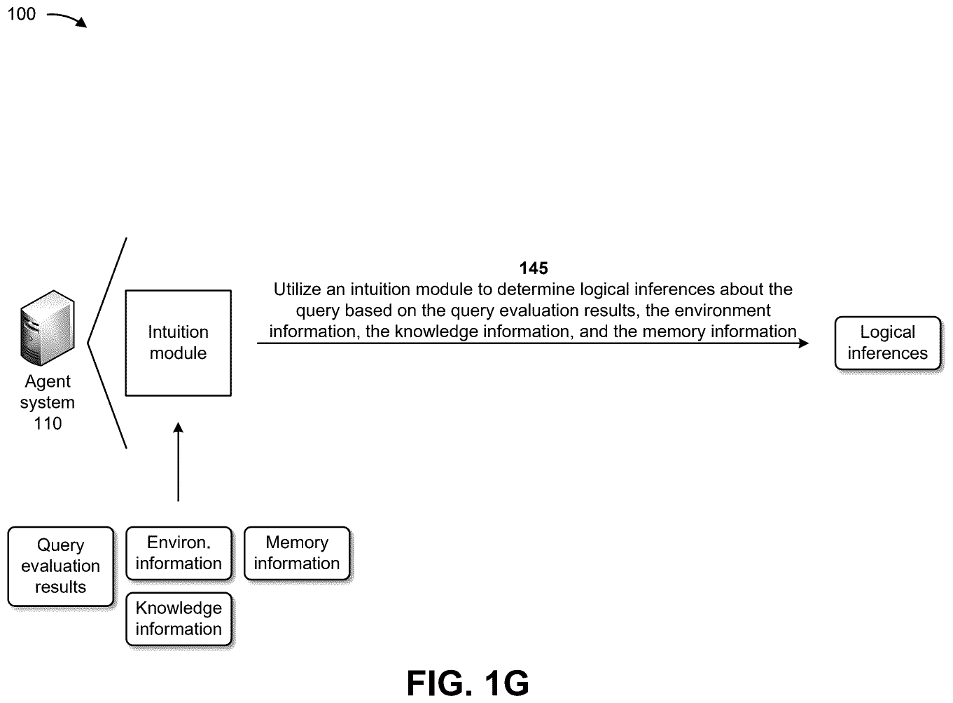

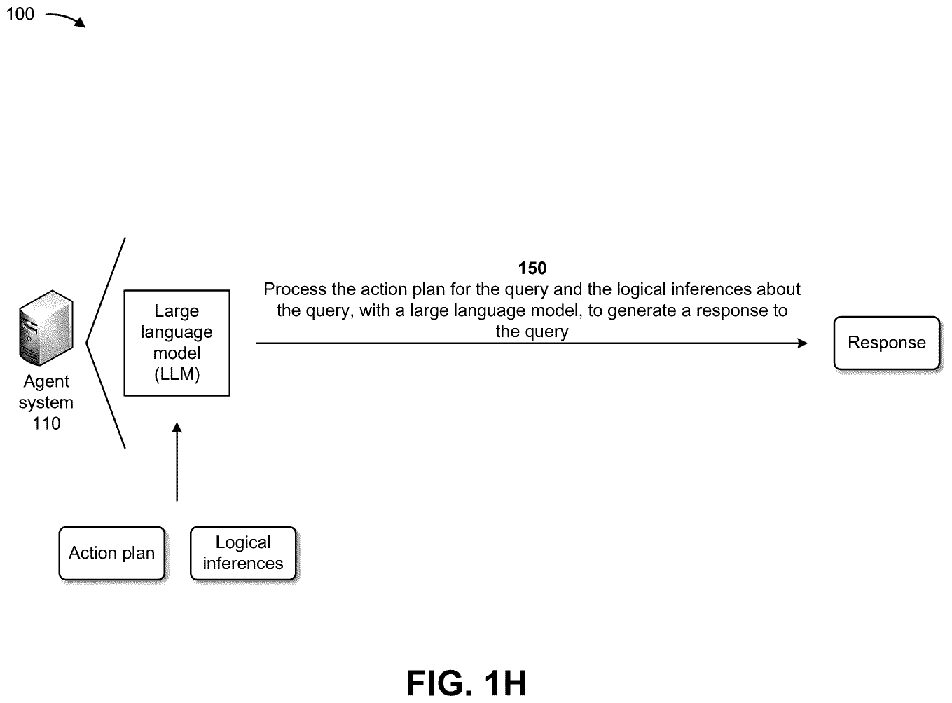

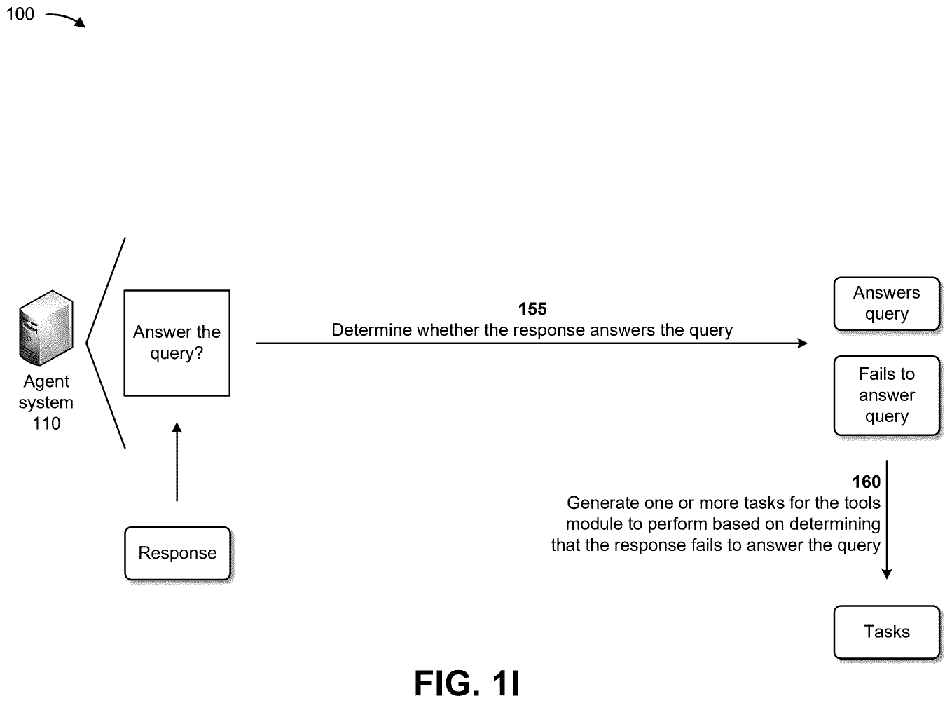

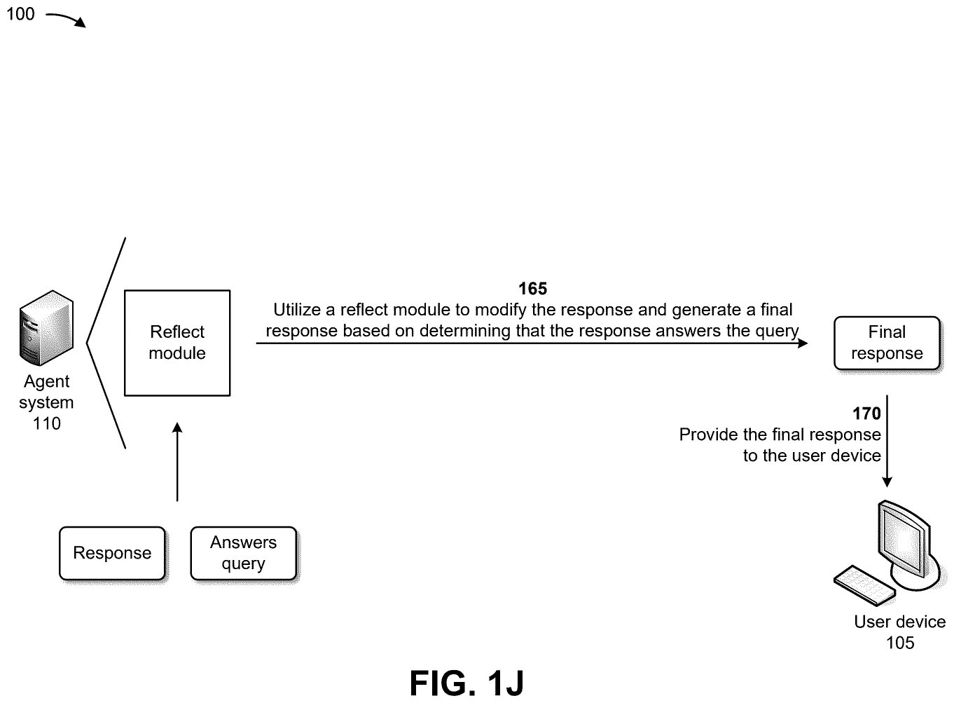

FIGS. 1A-1J are diagrams of an example 100 associated with providing modular agents for LLMs. As shown in FIGS. 1A-1J, example 100 includes a user device 105 associated with an agent system 110. Although a single user device 105 is depicted in the example 100, in some implementations, the agent system 110 may be associated with multiple user devices 105. Further details of the user device 105 and the agent system 110 are provided elsewhere herein.

As shown in FIG. 1A, and by reference number 115, the agent system 110 may receive a query from the user device 105. For example, a user may be associated with the user device 105, and may input the query to the user device 105. The user device 105 may provide the query to the agent system 110, and the agent system 110 may receive the query from the user device 105. The agent system 110 may interact with the user device 105 to obtain queries that require processing to generate suitable responses. The query may include a request for information, identification of a problem to be solved, and/or the like.

As further shown in FIG. 1A, and by reference number 120, the agent system 110 may evaluate the query to generate query evaluation results. For example, the agent system 110 may assess the content of the received query to determine a context of the query and a nature of the information or action requested by the query. This evaluation may provide information for subsequent generation of an action plan and formation of logical inferences that drive LLMs. In some implementations, when evaluating the query to generate the query evaluation results, the agent system 110 may partition the query into components that can be compared against known information. For example, the agent system 110 may utilize a reasoning process to partition the query into the components and align the components with relevant data points of the known information.

The query evaluation results may form the basis for an action plan for the query, such as a strategy for solving a problem posed by the query. In some implementations, the agent system 110 may incorporate additional features to enhance the evaluation results, such as assessing the query against a threshold of intuitive understanding. This may ensure that the query is processed in a most efficient manner, potentially relying on the intuitive knowledge already available within the agent system 110. An accuracy and relevance of the evaluation results may impact an effectiveness of the action plan for the query and the overall quality of a final response to the query.

As shown in FIG. 1B, the agent system 110 may include an evaluation module (reference number 1), a plan module (reference number 2), an intuition module (reference number 3), a reflect module (reference number 4), an LLM, a tools module (reference number 5), a memory module (reference number 6), a knowledge module (reference number 7), and a data structure (e.g., a database, a list, a table, and/or the like). In some implementations, the user device 105 and the LLM may be separate from the agent system 110. As further shown in FIG. 1B, the agent system 110 may receive the query from the user device 105, and may evaluate the query. The evaluation of the query may include the agent system 110 conducting an assessment of the query to produce evaluation results, as described above in connection with FIG. 1A. After evaluating the query, the agent system device may plan a response to the query based on the evaluation results and to generate an action plan. The planning step may include the agent system 110 strategizing a best approach to address the query, which may include formulating a problem-solving action plan. The action plan may provide a blueprint for subsequent interaction with various modules to effectively address the query.

As further shown in FIG. 1B, simultaneously, the agent system 110 may utilize the intuition module to intuitively determine logical inferences about the query, based on the evaluation results, environmental information from the tools module (e.g., stored in the data structure), factual and logical constructs from the knowledge module, memory information from the memory module, and/or the like. The intuition module may enable the agent system 110 to make reasoned judgments akin to human reasoning. If the query can be addressed by the intuition module, the agent system 110 may provide the query and the logical inferences about the query to the LLM. The reflection module may provide error checking and validation of an answer or response to the query (e.g., generated by the LLM) to ensure that the response is calibrated and precise before delivery to the user device 105.

As further shown in FIG. 1B, if the query cannot be addressed by the intuition module, the agent system 110 may utilize the tools module to generate tasks for further action. The tools module may add the tasks to a task list, which may provide an action-oriented resolution approach when intuitive reasoning and existing knowledge are insufficient for query resolution. The tasks may request further actions, such as API calls or function calls that aid in environment assessment and information gathering. The knowledge module may provide well-established facts and business logic to aid in the resolution of the query. The memory module may provide short term information and inference information to the response process. These modules collectively support the function of the intuition module by providing the requisite data for logical inferencing about the query. As further shown in FIG. 1B, the agent system 110 may generate a response to the query utilizing the LLM. The response may be based on the processed action plan and the logical inferences about the query. In this way, the agent system 110 may provide modular components (e.g., intuition, memory, and tools) that each contribute distinct information utilized to generate a final response provided to the user device 105.

As shown in FIG. 1C, and by reference number 125, the agent system 110 may generate an action plan for the query based on the query evaluation results. For example, the agent system 110 may assess the query received from user device 105 to produce the evaluation results, and may formulate, based on the evaluation results, a strategic plan (e.g., an action plan) designed to address the query effectively. The action plan may include a plan to solve a problem posed by the query, to provide information requested by the query, and/or the like. In some implementations, the action plan may delineate a course of action that the agent system 110 may deploy (e.g., employing the various modular components) to solve the query's identified problem. In some implementations, based on the query evaluation results (e.g., indicating an effectiveness of an initial response in answering the query), the agent system 110 may create tasks for the tools module when the initial response fails to answer the query. In some implementations, successful execution of the action plan, valid inference determination, and/or the like may be stored by agent system 110. The stored information may enhance the understanding of the LLM over time, and may enable the agent system 110 to potentially forgo future utilization of data structures for previously addressed queries, thereby streamlining response times and reducing computational overhead.

As shown in FIG. 1D, and by reference number 130, the agent system 110 may utilize a tools module to generate environment information based on application programming interfaces (APIs), function calls, and terminal access. For example, the agent system 110 may utilize the tools module to interact with an operational environment of the agent system 110. For example, the tools module may utilize APIs for interfacing with external applications, may utilize function calls for executing specific operations, may access terminal interfaces for command-line interactions, and/or the like. Through this multifaceted approach, the tools module may enable the agent system 110 to analyze and understand the operational environment, and to perform tasks efficiently and effectively in response to the query.

In some implementations, the tools module of the agent system 110 may extend the capabilities of the agent system 110 by enabling a modular approach to gathering information. For example, developers may create new tools within the tools module, which may provide the agent system 110 with expanded functionality to receive information from the operational environment and may facilitate generating the environment information utilized by the agent system 110 to execute informed actions in response to queries. The tools module may enable the agent system 110 to incorporate new and potentially more sophisticated tools as they become available.

The environment information may include context utilized by the agent system 110 to effectively process user queries, thus bolstering the overall responsiveness and accuracy of the agent system 110. The tools module may store the environment information in the data structure, and the agent system 110 may utilize the environment information to deliver finely tuned and contextually relevant responses to queries. The tools module may simplify the complexities associated with managing a variety of environmental data sources and may enable the agent system 110 to adapt to an ever-evolving technological landscape.

As shown in FIG. 1E, and by reference number 135, the agent system 110 may utilize a knowledge module to generate knowledge information based on well-established facts and business logic. For example, the knowledge module may perform an important role in the operation of the agent system 110. By processing well-established facts and business logic, the knowledge module provides the agent system 110 with a repository of knowledge information that is readily accessible. The agent system 110 may utilize the knowledge information to answer queries efficiently and accurately, especially when the queries relate to established knowledge or commonly understood business principles. The well-established facts may include historical data, widely accepted truths, and/or the like. The business logic may include rules, procedures, operations, constraints, and/or the like that govern operation of a particular business domain.

In some implementations, the agent system 110 may update the knowledge module over time with new facts and business logic that become established. This may ensure that the agent system 110 remains current and can incorporate the latest information into the knowledge module. The knowledge module may provide the agent system 110 with immediate access to a structured and reliable set of information, which may enable the agent system 110 to more effectively evaluate queries and produce relevant, factually-supported responses. The knowledge module may also increase the overall accuracy and usefulness of the LLM with which the agent system 110 interfaces, leading to enhanced user satisfaction. Moreover, the ability to generate the knowledge information reduces the need for external queries, optimizes a response time of the agent system 110, and conserves computational resources by using internally stored and verified information.

As shown in FIG. 1F, and by reference number 140, the agent system 110 may utilize a memory module to generate memory information based on short term information and inference information. For example, the agent system 110 may include the memory module that is configured to manage and retain information temporarily (e.g., short term information). The short term information may be retained briefly for immediate use and may be subsequently discarded upon use. The memory module may also generate inference information which may be utilized by the agent system 110 to make logical deductions or conclusions based on available data. The inference information may enable the agent system 110 to form responses and solutions that are contextually relevant and accurate to the queries. In one example, the agent system 110 may store a query, such as “How are you?,” as short term information, may recognize the greeting, and may respond appropriately without querying a database for irrelevant documents. For more complex interactions, the agent system 110 may generate responses based on the inference information by drawing from recent interactions or predefined knowledge to provide contextually appropriate outcomes.

In some implementations, the memory module may retain the memory information up to a specified data size or for a particular duration, thereby managing information volume and ensuring efficient use of resources of the agent system 110. By utilizing the memory module, the agent system 110 may reduce latency in response generation, may conserve processing resources by avoiding repetitive data retrieval tasks, and may enhance user experience through the provision of timely and accurate responses. In some implementations, the memory module includes a short term memory for the short term information and a working memory for the inference information.

As shown in FIG. 1G, and by reference number 145, the agent system 110 may utilize an intuition module to determine logical inferences about the query based on the query evaluation results, the environment information, the knowledge information, and the memory information. For example, as described above, the agent system 110 may evaluate the query to generate the query evaluation results, may utilize the tools module to generate the environment information, may utilize the knowledge module to generate the knowledge information, and may utilize the memory module to generate the memory information. The intuition module of the agent system 110 may process the query evaluation results, the environment information, the knowledge information, and the memory information to derive logical inferences about the query. The logical inferences may include certain facts or deductions that are determined without the need for conscious reasoning or detailed analytics each time an encounter with such an instance occurs.

The logical inferences determined by the intuition module of the agent system 110 may be compared to a threshold of intuitive understanding before being applied. This may ensure that the logical inferences align with logical and environmental contexts. The utilization of the intuition module to draw logical inferences may reduce dependency on continual queries by the agent system 110 to external data structures, may avoid unnecessary use of computational resources by the agent system 110, and may achieve efficiencies in time, accuracy, and relevancy of the response generated by the agent system 110. This may improve the overall effectiveness and human-like responsiveness of the agent system 110, ensuring that the agent system 110 operates not just as a database query tool but as an intelligent entity capable of simulating human-like reasoning.

As shown in FIG. 1H, and by reference number 150, the agent system 110 may process the action plan for the query and the logical inferences about the query, with an LLM, to generate a response to the query. The agent system 110 may utilize the LLM to generate the response to the query based on the action plan for the query and the logical inferences about the query. Processing the action plan and the logical inferences with the LLM enables the agent system 110 to utilize advanced language processing capabilities, thereby generating a response that is pertinent and accurately addresses the query. The LLM may synthesize the diverse inputs, such as the action plan (e.g., which may include a problem-solving strategy) and the logical inferences (e.g., which are based on the query evaluation results, the environment information, the knowledge information, and the memory information). The LLM may transform these inputs into a coherent and contextually relevant response. During the processing of the action plan and the logical inferences by the LLM, the agent system 110 may utilize the memory information, which may include both short term information reflective of immediate past interactions and inference information that involves reasoning over past knowledge. In some implementations, the agent system 110 may utilize the memory information to train the LLM to enhance the LLM's responses over time.

In some implementations, the agent system 110 may utilize one or more other LLMs, different than the LLM, to process the action plan and the logical inferences, and to generate the response to the query. In some implementations, the agent system 110 may update the knowledge module with new facts and business logic over time, to sustain the relevancy and accuracy of the responses generated by the LLM. The agent system 110 may store the response in a data structure to facilitate context-aware interactions for future queries. By utilizing the LLM, the agent system 110 may generate nuanced and considered responses that are reflective of human-like understanding and reasoning. This may greatly enhance the user interaction experience and may provide robustness of the agent system 110 as an intermediary.

As shown in FIG. 1I, and by reference number 155, the agent system 110 may determine whether the response answers the query. For example, the agent system 110 may assess the response to determine whether the response answers the query. This assessment may be based on whether the content of the response addresses the query, effectively answering a question posed by the query. In some implementations, the agent system 110 may determine that the response answers the query. Alternatively, the agent system 110 may determine that the response fails to answer the query.

As further shown in FIG. 1I, and by reference number 160, the agent system 110 may selectively generate one or more tasks for the tools module to perform based on determining that the response fails to answer the query. For example, when the agent system 110 determines that the response fails to answer the query, the agent system 110 may generate one or more tasks for the tools module to perform. When the response fails to satisfactorily address the query, the agent system 110 may utilize the tools module to generate environment information from the APIs, the function calls, and the terminal access, in order to enrich the response with additional or missing information. The generation of the one or more tasks may resolve any deficiencies in the response, thereby improving the ability of the agent system 110 to offer comprehensive and accurate information to the user.

As shown in FIG. 1J, and by reference number 165, the agent system 110 may selectively utilize a reflect module to modify the response and generate a final response based on determining that the response answers the query. For example, when the agent system 110 determines that the response answers the query, the agent system 110 may utilize the reflect module to modify the response and generate the final response. In some implementations, after determining that the response generated by the LLM answers the query, the agent system 110 may employ the reflect module to refine and validate the response. The final response generated by the reflect module may ensure that the response to the query is both accurate and contextually appropriate. The reflect module may confirm that the response is valid and ready for delivery to the user.

As further shown in FIG. 1J, and by reference number 170, the agent system 110 may provide the final response to the user device 105. For example, when the agent system 110 determines that the response answers the query and utilizes the reflect module to generate the final response, the agent system 110 may provide the final response to the user device 105. The user device 105 may provide the final response for display to the user. This may represent the completion of a query-response cycle, fulfilling the intent of the user's initial query. Furthermore, the expedient delivery of an accurate and contextually-appropriate final response may enhance user satisfaction and improve user experience.

In this way, the agent system 110 provides modular agents for LLMs. For example, the agent system 110 may mimic human cognitive processes for technical enhancements in human-AI interaction. The agent system 110 may receive an inquiry from a user and may utilize an intuition module or component within a reasoning module to generate a response. The agent system 110 may provide the response to the user. The agent system 110 may restrict the storage duration of inquired information based on predefined parameters, and may refresh the intuition module capabilities by updating the intuition module with new information. The agent system 110 may access external databases, and may update a knowledge module with new information. The agent system 110 may limit recall by excluding time-sensitive data, and may assess inquiries against intuitive understanding thresholds. Thus, the agent system 110 may conserve computing resources, networking resources, and/or other resources that would have otherwise been consumed by failing to properly answer questions appropriately and efficiently with an agent and an LLM, handling user complaints due to failing to properly answer questions appropriately and efficiently, failing to provide correct recommendations based on poorly designed agent and LLM systems, providing irrelevant and inaccurate responses based on poorly designed agent and LLM systems, and/or the like.

The agent system 110 may employ enhanced strategies for data retention and recall, comparable to human short term and working memory models, leading to optimized storage and retrieval processes. This may mitigate resource load by preventing the agent system 110 from engaging in unnecessary database interactions for information that can be quickly accessed or inferred internally. Through the use of function calls, terminal access, and APIs for real-time updates, the agent system 110 may enhance computational efficiency and minimize unnecessary data processing. The architectural modularity of the agent system 110 enables seamless extension with new functionalities and repurposing across diverse projects, thus conserving developmental resources. The structured memory management and the intuition-driven querying mechanism ensure that the agent system 110 maintains high processing efficiency by limiting the processing of extraneous or dated information, which in turn conserves processing resources, memory resources, networking resources, and/or the like.

As indicated above, FIGS. 1A-1J are provided as an example. Other examples may differ from what is described with regard to FIGS. 1A-1J. The number and arrangement of devices shown in FIGS. 1A-1J are provided as an example. In practice, there may be additional devices, fewer devices, different devices, or differently arranged devices than those shown in FIGS. 1A-1J. Furthermore, two or more devices shown in FIGS. 1A-1J may be implemented within a single device, or a single device shown in FIGS. 1A-1J may be implemented as multiple, distributed devices. Additionally, or alternatively, a set of devices (e.g., one or more devices) shown in FIGS. 1A-1J may perform one or more functions described as being performed by another set of devices shown in FIGS. 1A-1J.

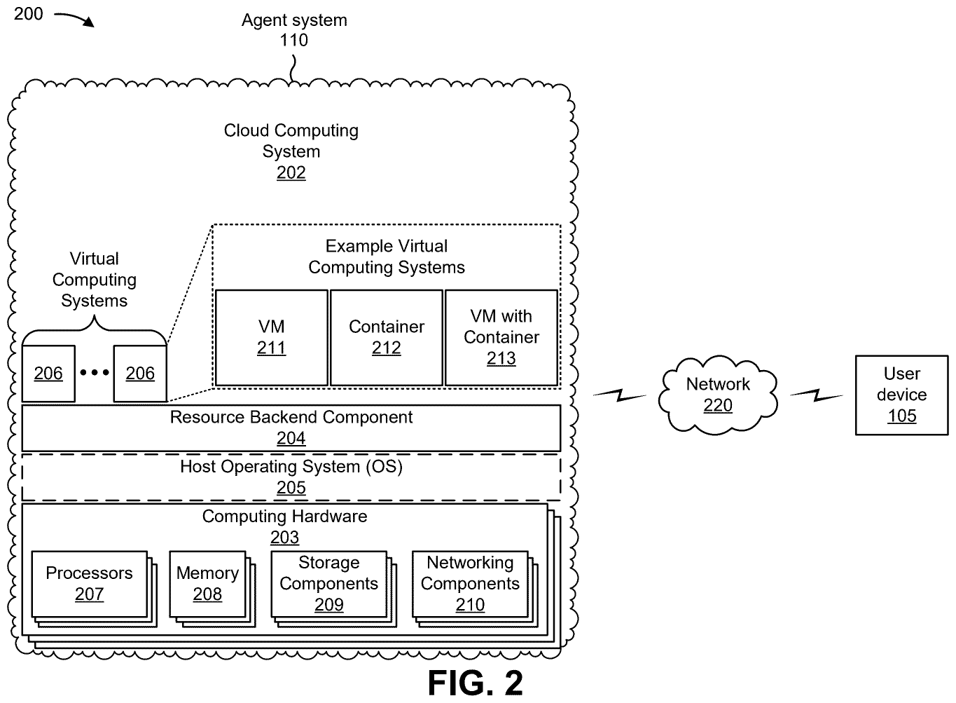

FIG. 2 is a diagram of an example environment 200 in which systems and/or methods described herein may be implemented. As shown in FIG. 2, the environment 200 may include the agent system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

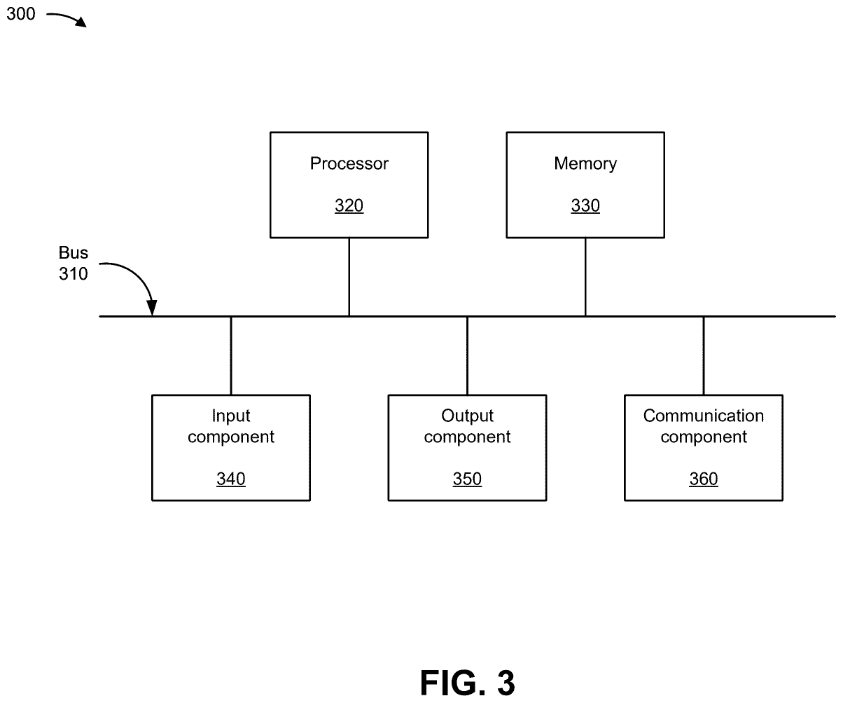

Although the agent system 110 may include one or more elements 203-213 of the cloud computing system 202, may execute within the cloud computing system 202, and/or may be hosted within the cloud computing system 202, in some implementations, the agent system 110 may not be cloud-based (e.g., may be implemented outside of a cloud computing system) or may be partially cloud-based. For example, the agent system 110 may include one or more devices that are not part of the cloud computing system 202, such as the device 300 of FIG. 3, which may include a standalone server or another type of computing device. The agent system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the agent system 110. In some implementations, the user device 105 and/or the agent system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

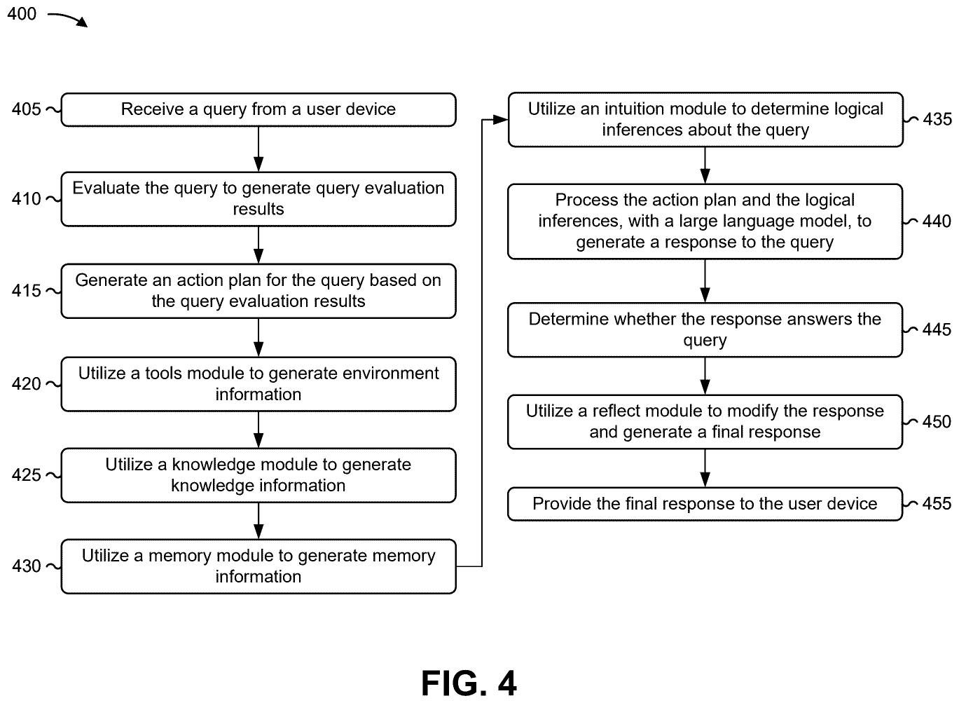

FIG. 4 is a flowchart of an example process 400 for providing modular agents for LLMs. In some implementations, one or more process blocks of FIG. 4 may be performed by a device (e.g., the agent system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a query from a user device (block 405). For example, the device may receive a query from a user device, as described above.

As further shown in FIG. 4, process 400 may include evaluating the query to generate query evaluation results (block 410). For example, the device may evaluate the query to generate query evaluation results, as described above.

As further shown in FIG. 4, process 400 may include generating an action plan for the query based on the query evaluation results (block 415). For example, the device may generate an action plan for the query based on the query evaluation results, as described above. In some implementations, the action plan for the query includes a plan to solve a problem posed by the query.

As further shown in FIG. 4, process 400 may include utilizing a tools module to generate environment information (block 420). For example, the device may utilize a tools module to generate environment information based on application programming interfaces, function calls, and terminal access, as described above.

As further shown in FIG. 4, process 400 may include utilizing a knowledge module to generate knowledge information (block 425). For example, the device may utilize a knowledge module to generate knowledge information based on well-established facts and business logic, as described above.

As further shown in FIG. 4, process 400 may include utilizing a memory module to generate memory information (block 430). For example, the device may utilize a memory module to generate memory information based on short term information and inference information, as described above. In some implementations, the memory module includes a short term memory for the short term information and a working memory for the inference information.

As further shown in FIG. 4, process 400 may include utilizing an intuition module to determine logical inferences about the query (block 435). For example, the device may utilize an intuition module to determine logical inferences about the query based on the query evaluation results, the environment information, the knowledge information, and the memory information, as described above.

As further shown in FIG. 4, process 400 may include processing the action plan and the logical inferences, with a large language model, to generate a response to the query (block 440). For example, the device may process the action plan for the query and the logical inferences about the query, with a large language model, to generate a response to the query, as described above.

As further shown in FIG. 4, process 400 may include determining whether the response answers the query (block 445). For example, the device may determine whether the response answers the query, as described above.

As further shown in FIG. 4, process 400 may include utilizing a reflect module to modify the response and generate a final response (block 450). For example, the device may utilize a reflect module to modify the response and generate a final response based on determining that the response answers the query, as described above.

As further shown in FIG. 4, process 400 may include providing the final response to the user device (block 455). For example, the device may provide the final response to the user device, as described above.

In some implementations, process 400 includes generating one or more tasks for the tools module to perform based on determining that the response fails to answer the query. In some implementations, process 400 includes preventing utilization of the reflect module to modify the response, and preventing provision of the final response to the user device based on determining that the response fails to answer the query.

In some implementations, process 400 includes storing the final response in a data structure for use as context for future queries received from the user device. In some implementations, process 400 includes utilizing the tools module, the knowledge module, the memory module, and the intuition module with one or more other large language models that are different than the large language model. In some implementations, process 400 includes training the large language model with the memory information.

In some implementations, process 400 includes restricting a storage duration of the memory information in the memory module based on predefined parameters. In some implementations, process 400 includes updating the memory information in the memory module with new memory information acquired over time in order to refresh a capability of the intuition module. In some implementations, process 400 includes accessing, based on determining that the response fails to answer the query, an external database to retrieve additional information for generating the response. In some implementations, process 400 includes updating the knowledge module with new facts and new business logic that become established over time. In some implementations, process 400 includes assessing the query against a threshold of intuitive understanding before utilizing the intuition module.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a query from a user device;
evaluating, by the device, the query to generate query evaluation results;
generating, by the device, an action plan for the query based on the query evaluation results;
utilizing, by the device, a tools module to generate environment information based on application programming interfaces, function calls, and terminal access;
utilizing, by the device, a knowledge module to generate knowledge information based on well-established facts and business logic;
utilizing, by the device, a memory module to generate memory information based on short term information and inference information;
utilizing, by the device, an intuition module to determine logical inferences about the query based on the query evaluation results, the environment information, the knowledge information, and the memory information;
processing, by the device, the action plan for the query and the logical inferences about the query, with a large language model, to generate a response to the query;
determining, by the device, whether the response answers the query;
utilizing, by the device, a reflect module to modify the response and generate a final response based on determining that the response answers the query; and
providing, by the device, the final response to the user device.

2. The method of claim 1, further comprising:
generating one or more tasks for the tools module to perform based on determining that the response fails to answer the query.

3. The method of claim 1, further comprising, based on determining that the response fails to answer the query:
preventing utilization of the reflect module to modify the response; and
preventing provision of the final response to the user device.

4. The method of claim 1, wherein the action plan for the query includes a plan to solve a problem posed by the query.

5. The method of claim 1, further comprising:
storing the final response in a data structure for use as context for future queries received from the user device.

6. The method of claim 1, further comprising:
utilizing the tools module, the knowledge module, the memory module, and the intuition module with one or more other large language models that are different than the large language model.

7. The method of claim 1, further comprising:
training the large language model with the memory information.

8. A device, comprising:
one or more processors configured to:
receive a query from a user device;
evaluate the query to generate query evaluation results;
generate an action plan for the query based on the query evaluation results;
utilize a tools module to generate environment information based on application programming interfaces, function calls, and terminal access;
utilize a knowledge module to generate knowledge information based on well-established facts and business logic;
utilize a memory module to generate memory information based on short term information and inference information;
utilize an intuition module to determine logical inferences about the query based on the query evaluation results, the environment information, the knowledge information, and the memory information;
process the action plan for the query and the logical inferences about the query, with a large language model, to generate a response to the query;
determine whether the response answers the query; and
selectively:
generate one or more tasks for the tools module to perform based on determining that the response fails to answer the query; or
utilize a reflect module to modify the response and generate a final response based on determining that the response answers the query; and
provide the final response to the user device.

9. The device of claim 8, wherein the one or more processors are further configured to:
restrict a storage duration of the memory information in the memory module based on predefined parameters.

10. The device of claim 8, wherein the one or more processors are further configured to:
update the memory information in the memory module with new memory information acquired over time in order to refresh a capability of the intuition module.

11. The device of claim 8, wherein the one or more processors are further configured to:
access, based on determining that the response fails to answer the query, an external database to retrieve additional information for generating the response.

12. The device of claim 8, wherein the one or more processors are further configured to:
update the knowledge module with new facts and new business logic that become established over time.

13. The device of claim 8, wherein the one or more processors are further configured to:
assess the query against a threshold of intuitive understanding before utilizing the intuition module.

14. The device of claim 8, wherein the memory module includes a short term memory for the short term information and a working memory for the inference information.

15. A non-transitory computer-readable medium storing a set of instructions, the set of instructions comprising:
one or more instructions that, when executed by one or more processors of a device, cause the device to:
receive a query from a user device;
evaluate the query to generate query evaluation results;
generate an action plan for the query based on the query evaluation results,
wherein the action plan for the query includes a plan to solve a problem posed by the query;
utilize a tools module to generate environment information based on application programming interfaces, function calls, and terminal access;
utilize a knowledge module to generate knowledge information based on well-established facts and business logic;
utilize a memory module to generate memory information based on short term information and inference information;
utilize an intuition module to determine logical inferences about the query based on the query evaluation results, the environment information, the knowledge information, and the memory information;
process the action plan for the query and the logical inferences about the query, with a large language model, to generate a response to the query;
determine whether the response answers the query;
utilize a reflect module to modify the response and generate a final response based on determining that the response answers the query; and
provide the final response to the user device.

16. The non-transitory computer-readable medium of claim 15, wherein the one or more instructions further cause the device to:
generate one or more tasks for the tools module to perform based on determining that the response fails to answer the query; and
prevent utilization of the reflect module to modify the response and provision of the final response to the user device based on determining that the response fails to answer the query.

17. The non-transitory computer-readable medium of claim 15, wherein the one or more instructions further cause the device to:
store the final response in a data structure for use as context for future queries received from the user device.

18. The non-transitory computer-readable medium of claim 15, wherein the one or more instructions further cause the device to:
train the large language model with the memory information.

19. The non-transitory computer-readable medium of claim 15, wherein the one or more instructions further cause the device to:
restrict a storage duration of the memory information in the memory module based on predefined parameters.

20. The non-transitory computer-readable medium of claim 15, wherein the one or more instructions further cause the device to:
update the memory information in the memory module with new memory information acquired over time in order to refresh a capability of the intuition module.
